(19) United States
(12) Patent Application Publication
(10) Pub. No.: US 2004/0223084 A1
(43) Pub. Date: Nov. 11, 2004

(54) Methods and apparatus for border processing in video distribution systems

(76) Inventor: Leon J. Stanger, Farmington, UT (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 10/431,754

(22) Filed: May 8, 2003

(51) Int. Cl. H04N 9/74

(52) U.S. Cl. 348/581; 348/445

(57) ABSTRACT

Methods and apparatus for border processing of video information in video distribution systems are disclosed. According to one aspect, the disclosed methods and apparatus store a video frame including picture content, determine an expansion coefficient for expansion of the video frame, expand the picture content of the video frame to fill at least a portion of a frame raster and output the expanded picture content.

### TECHNICAL FIELD

The present disclosure relates to digital television broadcast signal processing and, more particularly, to methods and apparatus for border processing in video distribution systems.

### BACKGROUND

The use of electronic communications media to provide access to a large quantity of video, audio, textual and data information has become prevalent. For example, the public switched telephone network (PSTN) is used routinely to transmit low speed digital data to and from personal computers. Cable television infrastructure carries, via coaxial cable, analog or digital cable television signals, and may also, in some instances, provides high speed Internet connections. In general, cable television infrastructures include many head-end or transmission stations that receive programming from a variety of sources and then distribute the programming to local subscribers via a coaxial cable network.

In contrast to cable or other wired systems, direct-to-home (DTH) satellite communication systems transmit directly to viewers over one hundred fifty audio and video channels, along with very high speed data. DTH systems typically include a transmission station that transmits audio, video and data to subscriber stations via satellite. One particularly advantageous example of a DTH satellite system is the digital satellite television distribution system utilized by the DIRECTV® broadcast service. This system transports digital data, digital video and digital audio to viewers' homes via high-powered Ku-band satellites.

During the operation of a DTH system, various program providers send programming material to transmission stations. If the transmission stations receive the programming in an analog form, the transmission stations convert it to a digital form. The transmission stations compress the digital video/audio programming (if needed), encrypt the video and/or audio, and format the information into data packets that are multiplexed with other data (e.g., electronic program guide data) into a plurality of bitstreams, which include identifying headers. Each packetized bitstream is modulated on a carrier and transmitted to a satellite, where it is relayed back to earth and received and decoded by the viewer's receiver station. The receiver station includes a satellite antenna and an integrated receiver/decoder (IRD) that is connected to appropriate output devices, such as a video display.

Whether an information distribution system is a digital cable system or a DTH system as described above, the amount of data needed to represent digital video is too large to transmit without some form of compression. The motion picture expert group (MPEG) was formed in 1988 to establish international standards for digital video and audio compression and distribution. The results were the MPEG-1 and MPEG-2 standards, which proscribe a compression system for use in digital video and audio distribution.

According to the MPEG-2 standard, the digital video is transformed and compressed before it is encoded and transmitted. Often, due to program content distribution techniques before video content is received at the transmission station, the video information to be processed for transmission has wide blanking and, therefore, does not include picture content that fills a full television raster for encoding. The wide blanking appears as black space on either side of the picture content (i.e., black bands on the left and right sides of the video program that the user desires to watch). MPEG encoding of a raster including wide blanking is inefficient. Specifically, the transition between the picture content and the wide blanking is difficult to compress because it is not uniform and appears to be a drastic transition in picture content. Consequently, to represent a transition that is merely an artifact of a distribution system that and is not, in fact, desired picture content, much data is created and bandwidth is wasted.

### BRIEF DESCRIPTION OF THE DRAWINGS

FIG. 1 is a diagram of an example direct-to-home (DTH) transmission and reception system.

FIG. 2 is a diagram of a display showing a raster including borders between blanking and picture content.

FIG. 3 is a diagram of additional detail of the example encoder of FIG. 1.

FIG. 4 is a diagram of additional detail of the example preprocessor of FIG. 3.

FIG. 5 is a flow diagram of an example raster expansion process that may be carried out by the preprocessor of FIG. 3.

### DETAILED DESCRIPTION

While the following disclosure is made with respect to example DIRECTV® broadcast services and systems, it should be understood that many other delivery systems are readily applicable to the disclosed apparatus and methods. Such systems include wired or cable distribution systems, ultrahigh frequency/very high frequency (UHF/VHF) radio frequency systems or other terrestrial broadcast systems (e.g., multipoint microwave distribution system (MMDS), local multipoint distribution services (LMDS), etc.), and fiber optic networks.

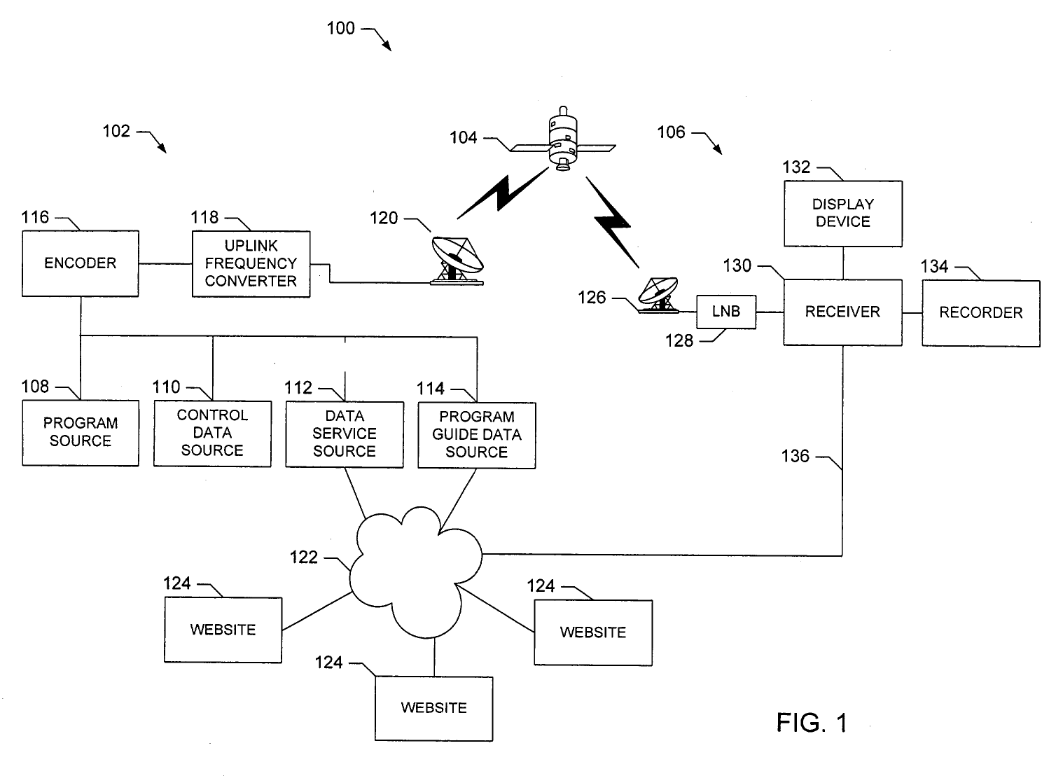

As shown in FIG. 1, an example DTH system 100 generally includes a transmission station 102, a satellite/relay 104 and a plurality of receiver stations, one of which is shown at reference numeral 106, between which wireless communications are exchanged. The wireless communications may take place at any suitable frequency, such as, for example, Ku-band frequencies. Information from the transmission station 102 is transmitted to the satellite/relay 104, which may be at least one geosynchronous or geo-stationary satellite that, in turn, rebroadcasts the information over broad geographical areas on the earth that include receiver stations 106.

In further detail, the example transmission station 102 of FIG. 1 includes one or more program sources 108, a control data source 110, a data service source 112, and one or more program guide data sources 114. The program sources 108 receive video and audio programming from a number of sources, including satellites, terrestrial fiber optics, cable or tape. The video and audio programming may include, but is not limited to, television programming, movies, sporting events, news, music or any other desirable content. The control data source 110 passes control data to the encoder 116. The control data may include data pertinent to the encoding process, or any other suitable information. The data service source 112 receives data service information and web pages made up of text files, graphics, audio, video, software, etc. Such information may be provided via a network 122 from one or more websites 124. The program guide data source 114 compiles information related to the codes used by the encoder 116 to encode the data that is broadcast.

During operation, information from one or more of these sources 108-114 passes to an encoder 116, which encodes the information for broadcast to the satellite/relay 104. Encoding, as described in detail below, includes, for example, expanding picture content to fill a raster to be compressed converting the information into data streams that are multiplexed into a packetized data stream or bitstream using a number of conventional algorithms. As part of the encoding, a header is attached to each data packet within the packetized data stream to facilitate identification of the contents of the data packet. The header also includes a program identifier (PID), one form of which is a service channel identifier (SCID) that identifies the data packet.

To facilitate the broadcast of information, the encoded information passes to an uplink frequency converter 118 that modulates a carrier wave and passes the modulated carrier wave to an uplink antenna 120, which broadcasts the information to the satellite/relay 104. In a conventional manner, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The satellite/relay 104 receives the modulated, encoded Ku-band bitstream and re-broadcasts it downward toward an area on earth that includes the receiver station 106. As shown in FIG. 1, the example receiver station 106 includes a reception antenna 126 that passes received signals to a low-noise-block (LNB) 128 that is further connected to a receiver 130. The receiver 130 may be a set-top box or may be a personal computer (PC) having a receiver card installed therein that decodes the information provided by the LNB 128 and couples the decoded information to a display device 132, such as, for example, a television set or a computer monitor. Additionally, the signals from the receiver 130 may be coupled to a recorder 134 used to record programming received by the receiver station 106. The recorder 134 may be, for example, a device capable of recording information on media, such as videotape or digital media such as a hard disk drive, a digital versatile disk (DVD), a compact disk (CD) and/or any other suitable media. The receiver station 106 may optionally incorporate a communication path 136 (e.g., Ethernet circuit or modem for communicating over the Internet) to the network 122 for transmitting requests and other data back to the transmission station 102 (or a device managing the transmission station 102 and overall flow of data in the system 100) and for communicating with websites 124 to obtain information therefrom.

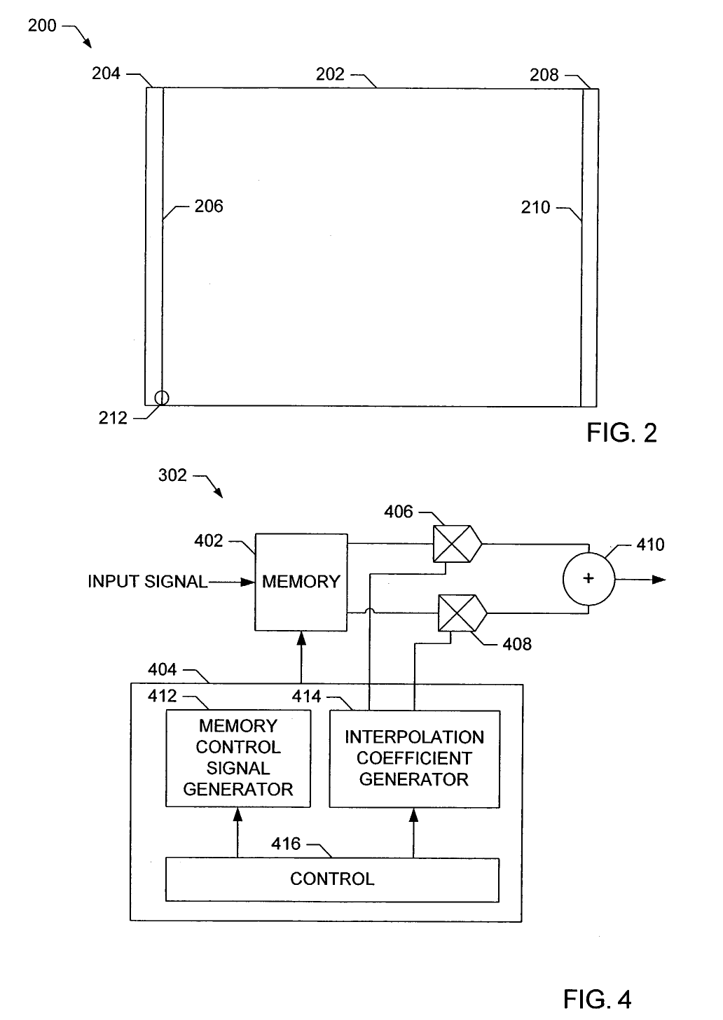

As shown in FIG. 2, a raster 200 of graphics provided by one or more of the sources 108-114 for encoding by the encoder 116 includes picture content 202 that is bounded by a left border 204 at a left boundary 206 and bounded by a right border 208 at a right boundary 210. The left and right borders 204, 208 may be blacked-out portions referred to as blanking, which results when the program content 202 does not completely fill the width of the raster 202. Ideally, the encoder 116 receives a full raster including only picture content 202 and not including the blanking of the borders 204, 208 because, as previously noted, the abrupt transition between the picture content 202 and the borders 204, 208 is difficult to compress and, therefore, requires significant bandwidth to transmit. A portion of the raster 200 is shown encircled at reference numeral 212 to highlight the boundary 206 between the left border 204 and the picture content 202.

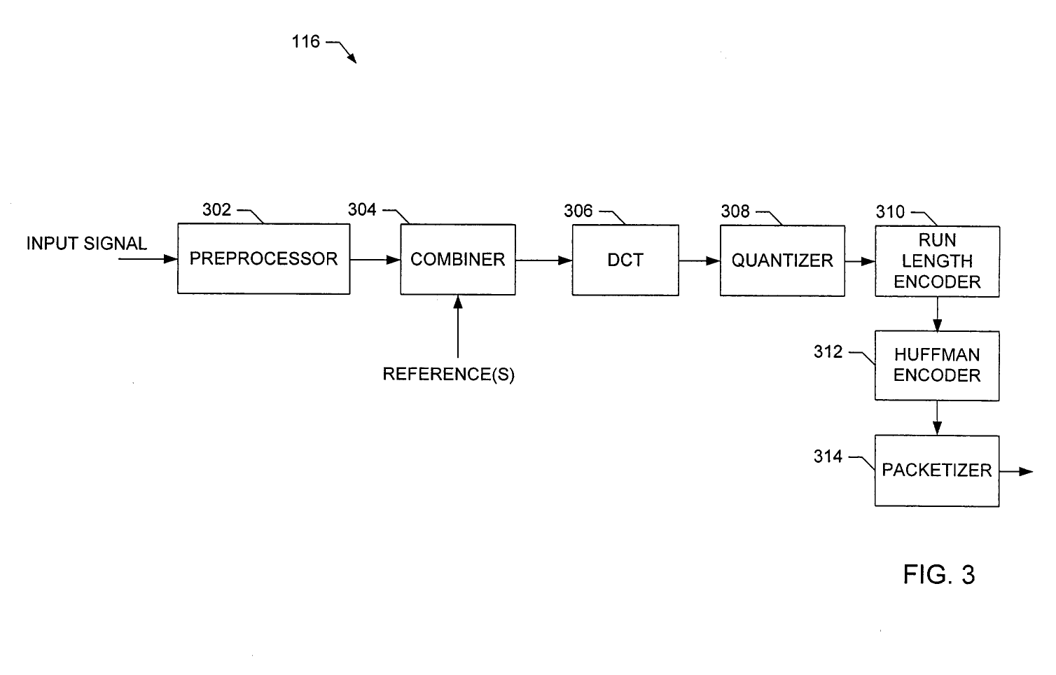

The example encoder 116, as shown in FIG. 3, includes a preprocessor 302, a combiner 304, a discrete cosine transformer (DCT) 306 and a quantizer 308. The encoder 116 also includes a run length encoder 310, a Huffman encoder 312 and a packetizer 314. Each of the items 302-314 may be implemented in dedicated hardware or in software executed on hardware. For example, as shown in FIG. 4, the preprocessor 302 may be embodied in a conventional computing system having a processor and memory, wherein the memory stores instructions that may be executed by the processor to cause the processor to implement the apparatus and methods described herein.

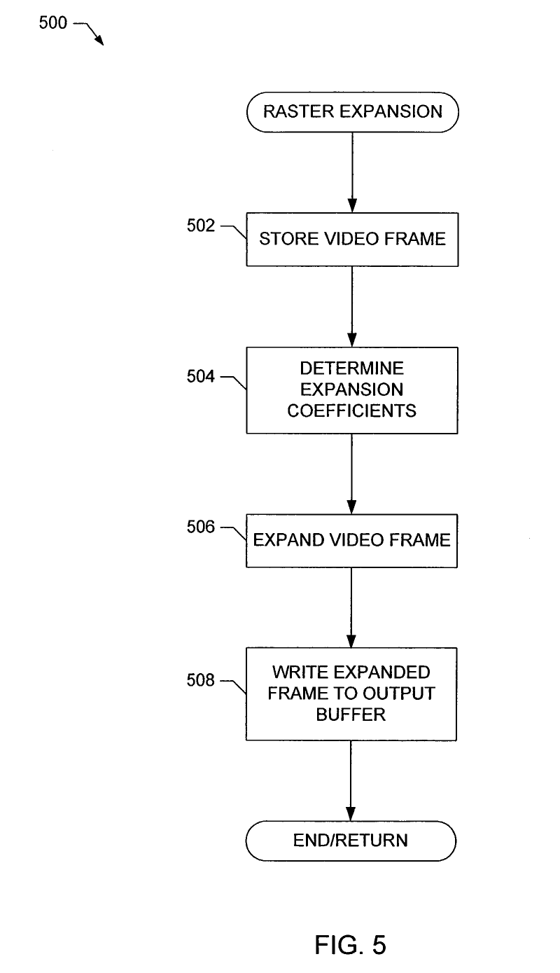

For example, as shown in FIG. 4 the preprocessor 302 includes a memory 402, a processor 404, two multipliers 406, 408 and a summer 410. In general, an input signal for broadcast is coupled to the memory 402 in which the signal is stored. The processor 404, as described in detail below in conjunction with FIG. 5, manipulates the input signal stored in memory 402 to expand the input signal to fill a raster. The expansion of the input signal may be carried out by stretching some or the entire picture represented by the input signal or by repeating portions of the picture represented by the input signal (e.g., the outermost few rows or columns of pixels of picture content may be repeated in the space normally left by the blanking).

The processor 404 is programmed with instructions that cause the processor 404 to implement the functions shown in FIG. 4. Software corresponding to the functions of FIG. 4 is described in conjunction with FIG. 5 as software stored in the memory 402 or some other memory, such as a program memory. For example, the processor 404 may implement a memory control signal generator 412 for interfacing to with the memory 402, an interpolation coefficient generator 414, which develops coefficients that dictate how much the picture represented by the input signal will be stretched, and a control block 416 that coordinates the functions of the blocks 412 and 414.

In operation, an input signal representing a frame of visual information is stored in the memory 402, which may be, for example, a dual port random access memory (RAM). The control block 416 dictates the portion of the picture stored in memory 402 to be expanded and the extent to which the expansion is to be carried out. Accordingly, the control block 416 uses the memory control signal generator 412 to access the portions of memory 402 containing information to be expanded and the control block 416 instructs the interpolation coefficient generator 414 to generate expansion coefficients. The expansion coefficients are provided to the multipliers 406, 408, which multiply memory contents by the coefficients. The outputs of the multipliers 406, 408 are coupled to the summer 410, which combines the product terms to create expanded picture information that will completely fill a raster. As noted previously, a completely filled raster is more easily and efficiently compressed. The output of the summer 410 is coupled to the combiner 304 as shown in FIG. 3. As will be readily appreciated by those having ordinary skill in the art, the functions performed by the preprocessor 302 of FIG. 4 are known in other contexts as digital zooming. For example, U.S. Pat. Nos. 5,798,792 and 5,268,758, which are hereby incorporated by reference in their entirety, describe digital zooming and interpolation.

Returning to the description of FIG. 3, the remainder of the encoder 116 is described as operating on a filled raster of information provided by the preprocessor 302. As will be readily appreciated by those having ordinary skill in the art, MPEG video consists of a group of frames that are displayed to viewers at 30 frames per second. Each frame of the group of frames consists of a number of slices composed of macroblocks of pixels. Each macroblock is formed by four blocks of eight pixels by eight pixels. MPEG video is distributed by breaking various frames of the group of frames into intra frames (I-frames), predicted frames (P-frames) and bidirectional frames (B-frames).

The encoder 116 is able to process any of I, P or B-frames. The general background of each of the I, P and B-frames is provided, along with an accompanying description of how such frames are processed by the encoder 116 after the frames are manipulated and expanded by the preprocessor 302.

I-frames are coded using only information present in the frame itself. Accordingly, I-frames rely on no other frames to generate a picture because they complete in and of themselves. I-frames provide potential random access points into the compressed video data because they are completely self-contained. I-frames are moderately compressed using transform coding and typically use approximately two bits per coded pixel.

During the processing of I-frames, the output from the preprocessor 302 is coupled to the combiner 304. The operation of the preprocessor 302 is described below in conjunction with FIG. 5. In general, the preprocessor 302 stretches the picture content in the information from the combiner 304 to fill completely a raster to be compressed, thereby eliminating the black border. The stretching may be linear (i.e., the entire picture may be stretched by a fixed quantity) or may be non-linear (i.e., certain portions of the picture may be stretched, while other portions are not). As an alternative, if the black border is small (e.g., on the order of two or three pixels), the preprocessor 302 may repeat some of the picture content edge pixels to fill the black space before the video information is coupled to further components of the encoder 116.

After preprocessing, the macroblock is provided to the DCT 306, which converts the macroblock information from the spatial domain to the frequency domain. The output from the DCT 306 is coupled to a quantizer 308. The combination of the processing carried out by the DCT 306 and the quanitzer 308 results in the zeroing of many of the frequency coefficients output from the quantizer 308.

The output from the quantizer 308 is coupled to a run length encoder 310 that converts the quanitzer output into run-amplitude pairs, in which each pair indicates a number of zero coefficients and the amplitude of a non-zero coefficient. The run-amplitude pairs from the run length encoder 310 are then coded by a Huffman encoder 312, which uses shortened codes for commonly occurring run-amplitude pairs and uses longer codes for less common run-amplitude pairs.

After the information has been Huffman encoded, it is passed to a packetizer 314 that formats the data into packets for transmission from the transmission station 102. The packetizer 314 may also perform any encryption or further encoding required to ensure privacy or data integrity of the information transmitted by the transmission station 102.

P-frames are coded with respect to the nearest, previous I or P-frame using a technique referred to as forward prediction. Like I-frames, P-frames can serve as a prediction reference for B-frames and future P-frames. Additionally, P-frames use motion compensation to provide more compression than is possible with I-pictures.

During encoding of P-frames, the combiner 304 of the encoder 116, in a known manner, combines the input signal with a reference frame by taking the difference therebetween. The remaining processing described above with respect to the DCT 306, the quantizer 308, the run length encoder 310, the Huffman encoder 312 and the packetizer 314, are then carried out on the output from the preprocessor 302.

B-frames are pictures that use both a past and future pictures as a reference. This bidirectional prediction technique provides the most compression, as compared to I or P-frames, because it uses the past and future frames as references, however, the computation time is the largest.

The encoder 116 processes B-frames by combining past and future reference macroblocks with the input signal. This process is well known any may be carried out by subtracting a combination of the past and future reference macroblocks from the target macroblock.

FIG. 5 shows one example raster expansion process 500 that may be carried out by the preprocessor 302 to expand the information from the combiner 304 so that it may be efficiently compressed in an MPEG system. The preprocessor 302 receives and stores a frame (block 502), which includes picture information and borders where the picture information does not completely fill the raster.

Expansion coefficients for the frame are then determined (block 504). The expansion coefficients may be dynamically determined based on an analysis of the frame itself and the boundary location between any border and picture content. For example, the border size may be determined over a number of frames based on an average size of the borders of such frames. The expansion coefficients are then selected to eliminate the average border size.

As an alternative to dynamically determining expansion coefficients based on an average border size, the entire raster of information may be linearly expanded by a fixed factor of, for example, 1%-2%. Such a fixed expansion would be empirically pre-determined so that a raster would nearly always be filled with picture information and there would be, in fact, no border present in the raster. In one arrangement, the expansion is symmetrical in both the horizontal and vertical directions. In such a case, one expansion coefficient could be used to expand the entire raster contents by a fixed quantity.

While symmetrical expansion is one manner in which the frames could be expanded, a frame could be expanded in only the horizontal direction. Horizontal expansion, though it would introduce asymmetry in the frame, may be used when only small amounts of expansion are needed to move the boundary of the border and the picture information to a block or macroblock or to completely fill the raster with picture information. As will be readily appreciated, asymmetrical expansion could be carried out using two different expansion coefficients, one for the horizontal expansion and one for the vertical expansion.

Additionally, while a 1%-2% linear expansion throughout the frame is noted above, it is also contemplated that, in some instances, it may be desirable or necessary only to expand the outer areas of the frame. This non-linear expansion could, for example, expand only the outer 10%-20% of the frame, leaving the center portion of the frame, which is the portion most often seen by viewers, unaltered. For example, non-linear expansion of the outermost two blocks by 5% may be carried out. Non-linear expansion is advantageous when only a small amount of expansion is needed to fill the raster. Non-linear expansion could be carried through the selective application of a single expansion coefficient. For example, the inner portion of the frame or raster could be unexpanded and the outer portion of the frame or raster could be expanded by a quantity dictated by a single expansion coefficient (e.g., 5%).

After the expansion coefficients have been generated (block 504), the process 500 then expands the stored frame by the expansion coefficients (block 506). To preserve the luminance and chrominance of the frame, the frame should be processed in two dimensions to retain the symmetry and the aspect ratio of the expanded image. The expansion or interpolation of the frame information may be carried out in a manner similar or identical to that of a digital zoom, such as is disclosed in U.S. Pat. Nos. 5,798,792 and 5,268,758.

After the frame has been expanded (block 506), the expanded frame is written, for example, to an output buffer that feeds the DCT 406 (block 508). The remaining processing of the frame will yield an efficiently compressed frame that may be represented by less information than a frame having a border interface that falls in the midst of a block or macroblock. As noted above, as an alternative to generating expansion coefficients, picture content could be repeated in place of the border. For example, the outermost pixels of picture content could be repeated once or several times to fill the border with picture content to replace the blanking.

Although the foregoing describes horizontal expansion of picture information to extend picture information to fill a raster or to put a boundary of the border and the picture information to a block or macroblock, vertical expansion may also be carried out. Vertical expansion may be used to cover for blank video lines. As with the horizontal expansion described above, vertical expansion may be carried out using linear or non-linear techniques. Additionally, the expansion may be fixed (e.g., a constant 1%-2%) or may vary from frame to frame.

What is claimed is:

1. A transmission station comprising:
a program source configured to output a video frame including picture content;
a preprocessor coupled to the program source and configured to expand the picture content of the video frame to fill at least a portion of a frame raster;
a compressor coupled to the preprocessor and configured to compress the expanded picture content; and
a transmitter coupled to the compressor and configured to broadcast the compressed and expanded picture content.

2. A transmission station as defined by claim 1, wherein the preprocessor expands the picture content of the video frame according to an expansion coefficient.

3. A transmission station as defined by claim 2, wherein the preprocessor is configured to determine the expansion coefficient based on the picture content of the video frame in comparison to the frame raster.

4. A transmission station as defined by claim 2, wherein the expansion coefficient is a fixed value.

5. A transmission station as defined by claim 1, wherein the preprocessor is configured to expand the picture content of the video frame in a horizontal direction.

6. A transmission station as defined by claim 1, wherein the preprocessor is configured to expand the picture content of the video frame to fill substantially the frame raster.

7. A transmission station as defined by claim 1, wherein the preprocessor expands the picture content of the video frame by repeating visual information located at an outer portion of the frame.

8. A transmission station as defined by claim 1, wherein the transmitter comprises an uplink frequency converter configured to broadcast the compressed and expanded picture content to a satellite.

9. A transmission station as defined by claim 1, wherein the preprocessor expands the picture content of the video frame linearly.

10. A transmission station as defined by claim 1, wherein the preprocessor expands the picture content of the video frame non-linearly.

11. A transmission station as defined by claim 10, wherein the non-linear expansion of the picture content of the video frame comprises expanding an outer portion of the picture content of the video frame and not expanding an inner portion of the picture content.

12. A method of broadcasting video information, the method comprising:
storing a video frame including picture content;
determining an expansion coefficient for expansion of the video frame;
expanding the picture content of the video frame to fill at least a portion of a frame raster; and
outputting the expanded picture content.

13. A method as defined by claim 12, wherein determining the expansion coefficient is based on the stored video frame.

14. A method as defined by claim 12, wherein the expansion coefficient is a fixed value.

15. A method as defined by claim 12, further comprising expanding the picture content in a horizontal direction.

16. A method as defined by claim 12, further comprising expanding the picture of the video frame content to fill substantially the frame raster.

17. A method as defined by claim 12, wherein the picture content of the video frame is expanded by repeating visual information located at an outer portion of the frame raster.

18. A method as defined by claim 12, wherein the picture content of the video frame is expanded linearly.

19. A method as defined by claim 12, wherein the picture content of the video frame is expanded non-linearly.

20. A method as defined by claim 19, wherein the non-linear expansion of the picture content of the video frame comprises expanding an outer portion of the picture content of the video frame and not expanding an inner portion of the picture content of the video frame.

21. A machine-accessible medium having a plurality of machine accessible instructions that, when executed, cause a machine to:
store a video frame including picture content;
determine an expansion coefficient for expansion of the video frame;
expand the picture content of the video frame to fill at least a portion of a frame raster; and
output the expanded picture content.

22. A machine-accessible medium as defined by claim 21, wherein determining the expansion coefficient is based on the stored video frame.

23. A machine-accessible medium as defined by claim 21, wherein the expansion coefficient is a fixed value.

24. A machine-accessible medium as defined by claim 21, further comprising expanding the picture content of the video frame in a horizontal direction.

25. A machine-accessible medium as defined by claim 21, further comprising expanding the picture content of the video frame to fill substantially the frame raster.

26. A machine-accessible medium as defined by claim 21, wherein the picture content of the video frame is expanded by repeating visual information located at an outer portion of the frame raster.
